(19) United States
(12) Patent Application Publication
(10) Pub. No.: US 2008/0109150 A1
(43) Pub. Date: May 8, 2008

(54) STARTER INTER-LOCK FOR AN INTERNAL COMBUSTION ENGINE

(76) Inventors: Jesse L. Pfohl, Park View, IA (US); Michael L. Frank, Cedar Falls, IA (US); Kevin Pfohl, Dickeyville, WI (US); Mark Benedict, Dubuque, IA (US); Richard T. Hurban, Cedar Falls, IA (US); Christopher J. Maifield, Dubuque, IA (US)

Correspondence Address: TAYLOR & AUST, P.C., P.O. Box 560, 142. S Main Street, Avilla, IN, 46710, US

(21) Appl. No.: 11/557,295

(22) Filed: Nov. 7, 2006

(51) Int. Cl. F02D 45/00

(52) U.S. Cl. 701/113; 123/179.3

(57) ABSTRACT

An internal combustion engine includes a flywheel, a starter for rotatably driving the flywheel, at least one starter parameter indicator, and an engine control module. Each indicator provides an output signal representing a start or no-start condition for the starter. The engine control module is coupled with the starter and one or more indicators. The engine control module controllably actuates the starter, dependent upon the output signal from each indicator.

### FIELD OF TH INVENTION

The present invention relates to internal combustion engines, and, more particularly, to starter systems for such engines.

### BACKGROUND OF THE INVENTION

A work machine such as used in the agricultural, forestry and construction industries typically includes an internal combustion (IC) engine providing motive force to a plurality of wheels or tracks. Examples of such work machines include agricultural tractors and combines, forestry timber harvesters, and construction track hoes and backhoes. The IC engines used in such work machines may be of the compression ignition type (e.g., diesel engines) or spark ignition type (e.g., gasoline engines).

Regardless of whether the IC engine is configured as a compression or spark ignition engine, a flywheel is typically provided at one end of a crankshaft. The flywheel provides inertial mass for smooth operation of the engine, and also typically has a toothed outer or inner periphery which is engaged by the starter during a starting sequence, such as occurs when an operator moves a starter switch (e.g., an ignition key) to a start position. The starter has an electronmechanically engaged small diameter gear which moves in an axial direction to engage the toothed flywheel when actuated using the starter switch.

A problem can occur from an operator over cranking the starter for too long a period of time. For example, diesel engines relying upon compression ignition start harder during cold weather when the fuel is colder and at a higher viscosity. Most diesel engines include a “glow plug” which in essence is an inline heater for heating the fuel prior to injection into the combustion cylinder. However, the metal surfaces of the injectors, cylinder liners, piston crowns, etc. may still be very cold and not conducive to the compression ignition process.

One solution is to use a block heater which is in communication with the liquid cooling jacket of the IC engine and warms up the fuel and various metal parts of the IC engine. It will be appreciated that given the thermal mass of the IC engine, this takes a considerable amount of time to heat the IC engine, and electrical plug-ins are not always available at a given work site. Another possible solution is to use starting fluid including ether as an active ingredient, but this can also be hard on an IC engine.

The starter includes an electric motor with a high amperage electrical input requirement. When the starter is cranked for too long a period of time (i.e., over cranked), the batteries of the work machine may be discharged. Moreover, the electric motor of the starter may fail, which is a primary problem that keeps the IC engine from being started, or keeps a work machine from being utilized. Operational instructions provide direction on starter motor operation indicating starter motor engagement times (cranking times). However, replacement of starter motors often results in warranty claims (returns and allowances expenses), and machine down time regardless of operational instructions.

A secondary problem may occur when a starter is engaged after the IC engine is already running. The outer toothed surface of the flywheel typically rotates faster than the rotational speed of the starter motor during operation. Engaging the starter when the IC engine is already running may result in physical damage to the teeth profiles on the flywheel or starter, or damage to the electric motor of the starter.

What is needed is a starter system for an IC engine which is configured to avoid damage to the starter and/or flywheel, such as may occur from over cranking the starter or engaging the starter when the IC engine is already running.

### SUMMARY OF THE INVENTION

The invention in one form is directed to an internal combustion engine including a flywheel, a starter for rotatably driving the flywheel, at least one starter parameter indicator, and an engine control module. Each indicator provides an output signal representing a start or no-start condition for the starter. The engine control module is coupled with the starter and one or more indicators. The engine control module controllably actuates the starter, dependent upon the output signal from each indicator.

The invention in another form is directed to a method of operating an internal combustion engine, including the steps of: requesting an energization of a starter; verifying at least one starter parameter indicator representing a start condition or no-start condition for the starter; and controllably actuating the starter, dependent upon the requested energization of the starter and each indicator corresponding to a start condition.

### BRIEF DESCRIPTION OF THE DRAWINGS

FIG. 1 is a schematic illustration of a work machine including an embodiment of an internal combustion engine of the present invention;

FIG. 2 is a high level flowchart illustrating an embodiment of a method of operating an internal combustion engine of the present invention; and

FIG. 3 is a more detailed flow chart illustrating an embodiment of the method of operating an internal combustion engine of the present invention.

### DETAILED DESCRIPTION OF THE INVENTION

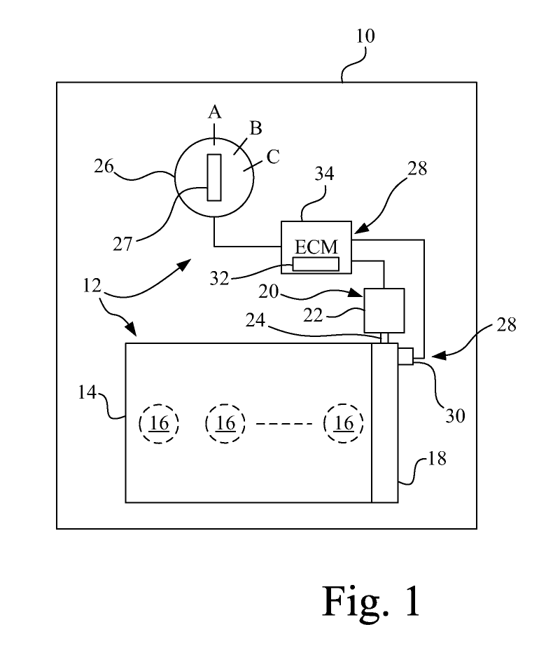

Referring now to the drawings, and more particularly to FIG. 1, there is shown a work machine 10 which may include an embodiment of an IC engine 12 of the present invention. Work machine 10 may be of any suitable type such as an agricultural, forestry, construction or industrial work machine. Examples include tractors, combines, swathers, timber harvesters, front end loaders, backhoes, track hoes, skid steers, etc.

IC engine 12 is assumed to be a diesel engine in the embodiment shown, but could be a different type of IC engine such as a spark ignition engine (gasoline or propane). IC engine 12 may be used within a work machine such as described above, or may be a stationary engine such as used in generator sets, irrigation or other engine driven pumps. IC engine 12 includes a block 14 with a plurality of combustion cylinders 16. The number of combustion cylinders can vary depending upon the engine, such as 6, 8, 10 or 12 combustion cylinders. A plurality of pistons (not specifically shown) are reciprocally disposed within the respective combustion cylinders 16. The pistons are typically connected via respective piston rods with a crankshaft (not shown) which is coupled with a flywheel 18 at one end thereof.

A starter 20 includes an electric motor 22 and an electromechaniccally engaged gear 24 which engages flywheel 18 to start compression ignition within IC engine 12. Starter 20 is of course sized dependent upon the size of IC engine 12.

Starter switch 26 includes a keyslot 27 for receiving a key (not shown). Keyslot 27 is movable between a stop position A, a run position B, and a start position C. Switch 26 may also include an accessory power position, if desired. Alternatively, it is also known to provide an on-off power switch working in conjunction with a momentary push-type starter switch for energizing starter 20. As another alternative, the starter switch could be configured as a momentary push-type button with two functions. Pressing the button a first time would provide power to an ignition relay that powers up the cab. Once ignition power (run position) is on, pressing the momentary button again would provide a start command to the engine controller to energize the starter. A separate momentary push-type button would then be used to turn off the ignition.

One or more starter parameter indicators 28 provide an output signal representing a start condition or no-start condition for starter 20. In other words, when a start request is initiated by turning starter switch 26 to start position C, starter 20 cannot be started if indicator(s) 28 do not provide an appropriate output signal. In the embodiment shown, IC engine 12 includes two indicators 28 corresponding to a start condition or no-start condition for starter 20. More particularly, one indicator 28 is in the form of a run indicator 30 indicating a run condition of internal combustion engine 12, and the other indicator 28 is in the form of a time-out indicator 32 indicating the cranking time of starter 20. Run indicator 30 is in the form of an RPM sensor associated with flywheel 18 providing an output signal representing an RPM of flywheel 18. If the sensed RPM of flywheel 18 corresponds to a predetermined speed such as a speed which is higher than the input drive speed of starter 20, then IC engine 12 is already running and starter 20 is not actuated. Other types of sensors providing output signals corresponding to a run state of IC engine 12 are possible, such as sensors detecting combustion within cylinders 16, rotation of the crankshaft, etc.

Time-out indicator 32 is in the form of a timer or counter contained internally within an engine control module (ECM) 34. Timer 32 provides a time-out signal corresponding to an excess cranking time of starter 20. To that end, timer 32 is started when starter switch 26 is in start position C, and times out after a predetermined period of time.

ECM 34 is also coupled with starter 20, starter switch 26, and run indicator 30. ECM 34 controllably actuates starter 20, dependent upon the status of starter switch 26 and starter parameter indicators 28. More particularly, ECM 34 actuates starter 20, dependent upon a logical boolean operation of the output signals from each indicator 28 and the start position C of starter switch 26. If starter switch 26 is moved to start position C, run indicator 30 indicates that IC engine 12 is not running, and the time-out period for starter 20 has not been exceeded, then ECM 34 energizes motor 22 of starter 20. If IC engine 12 is already running, then ECM 34 will not energize motor 22 of starter 20 resulting in a no-start condition. When the time-out period is reached, ECM 34 deenergizes starter 20 resulting in a no-start condition for a preset period of time.

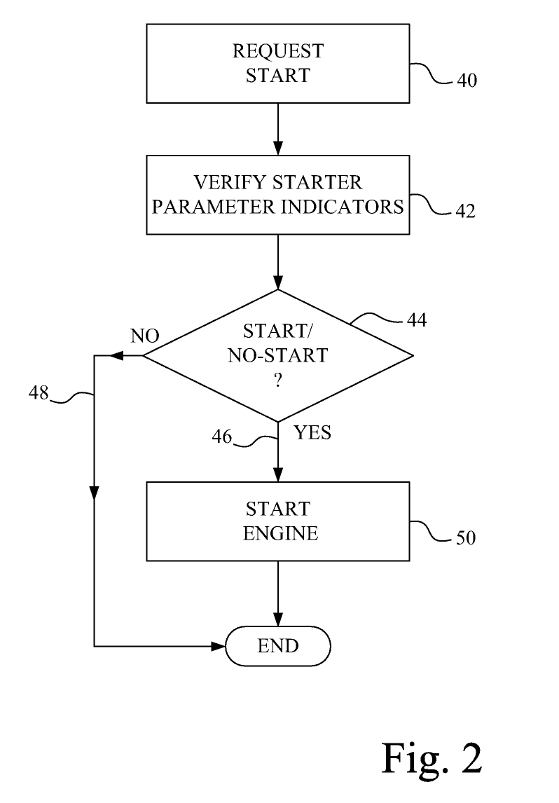

Referring now to FIG. 2, there is shown a high level flowchart which will be used to describe an embodiment of the method of operating IC engine 12 shown in FIG. 1. A starting sequence is requested to energize starter 20 by moving starter switch 26 to start position C (block 40). ECM 34 checks the status of starter parameter indicators 28, including run indicator 30 and time-out indicator 32, to verify whether a start condition or no-start condition exists for starter 20 (block 42). If a start condition exists (decision block 44, line 46), then ECM 34 energizes motor 22 of starter 20 (block 50). On the other hand, if a no-start condition exists (line 48), then ECM 34 does not energize or deenergizes motor 22 of starter 20.

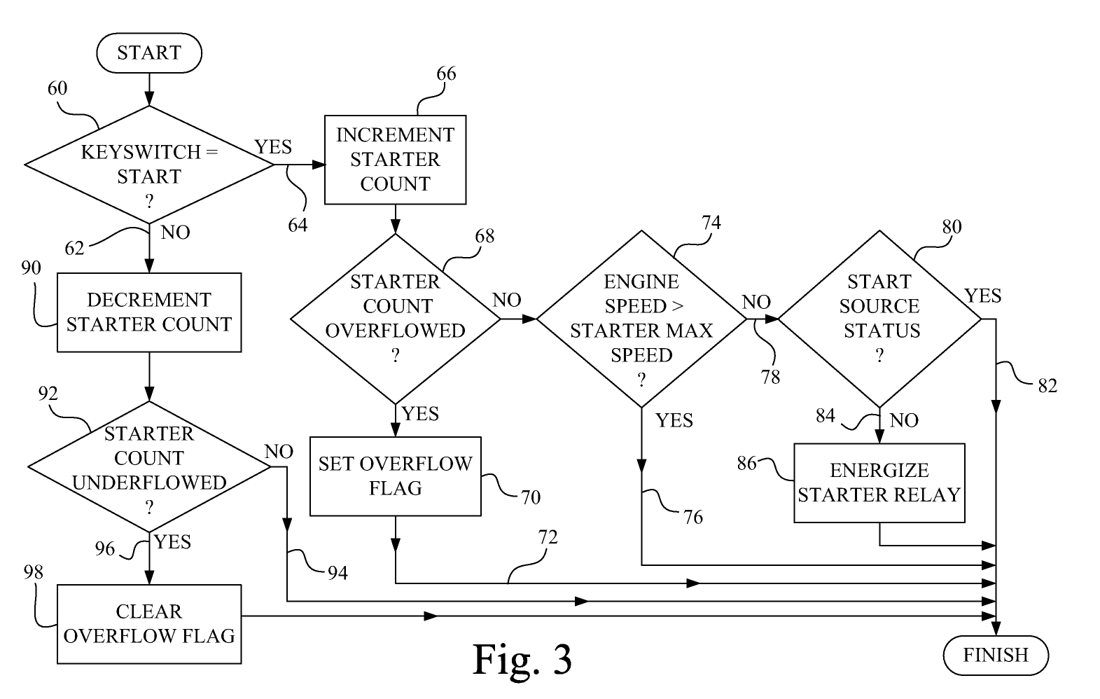

Referring now to FIG. 3, there is shown a lower level flowchart of an embodiment of a method of operating IC engine 12. When starter switch 26 is moved from the off position A (decision block 60), a determination is made as to whether the switch is in run position B (no, line 62) or start position C (yes, line 64). If starter switch 26 is in the start position C, then a counter is incremented by a predetermined amount (e.g., incremented by 1; block 66). The value of the counter is then compared with a predetermined overflow value (decision block 68). If the counter is overflowed, meaning that the maximum starter cranking time has been exceeded (e.g., 30 seconds), then the overflow flag is set (block 70), the starter is not energized and the process ends (line 72). Otherwise, if the counter is not overflowed, meaning that the maximum starter cranking time has not been exceeded, then a determination is made to determine if the engine is already running. This may be determined by comparing the sensed engine speed, such as by using RPM sensor 30, with the starter speed (decision block 74). If the IC engine 12 is already running, then the starter is not engaged and the process ends (line 76). On the other hand, if the engine is not already running (line 78), then a diagnostic feedback received from starter 20 is compared to the starter relay output (block 86). If the feedback indicates that the starter solenoid has been energized then power is not applied to the starter relay, and a mismatch starter source status is set and the process ends (line 82). If the starter relay has been energized (block 86) and the feedback from the starter 20 indicates it has not had power applied to the starter solenoid after a specified duration, then a mismatch starter source status is set and the process ends (line 82). If either the mismatch start source or overflow flag is set the starter relay will not be energized (block 80). Otherwise, if the status feedback from starter 20 indicates that power needs to be applied to the solenoid of motor 22 (line 84), then ECM 34 controllably energizes the solenoid of starter 20 (block 86). The process then repeats while the starter switch 26 is held in the start position C until the engine starts or an overflow occurs.

After the starter switch 26 is released and moves to run position B (line 62), then the accumulated value of the counter described above (with reference to block 66 and decision block 68) is decremented a predetermined amount (block 90). The counter value is then compared with a predetermined underflow value (e.g., 0; decision block 92). If the overflow flag is set (block 70), and the counter value has not yet reached the underflow value, or the mismatch starter source status is set, then the starter cannot be energized and the process ends (line 94). On the other hand, if the underflow value has been reached (line 96), the start source status is cleared (block 98), and if the mismatch starter source status is clear, then the starter can again be energized as described above when the starter switch is moved to start position C (block 86).

Having described the preferred embodiment, it will become apparent that various modifications can be made without departing from the scope of the invention as defined in the accompanying claims.

1. An internal combustion engine, comprising:
a flywheel;
a starter for rotatably driving said flywheel;
at least one starter parameter indicator, each said indicator providing an output signal representing one of a start and no-start condition for said starter; and
an engine control module coupled with said starter and said at least one indicator, said engine control module controllably actuating said starter, dependent upon said output signal from each said indicator, and
wherein said at least one indicator includes two indicators, one said indicator comprising a run indicator indicating said run condition of said internal combustion engine, and an other said indicator comprising a time-out indicator indicating said cranking time of said starter.

2. The internal combustion engine of claim 1, further including a starter switch having a start position, said engine control module coupled with said switch and controllably actuating said starter, dependent upon said output signal from each said indicator and said start position of said switch.

3. The internal combustion engine of claim 2, wherein said engine control module actuates said starter, dependent upon a logical boolean operation of each of said output signal from each said indicator and said start position of said switch.

4. (canceled)

5. (canceled)

6. The internal combustion engine of claim 1, wherein said run indicator includes an RPM sensor providing an output signal representing an RPM of said internal combustion engine.

7. The internal combustion engine of claim 1, wherein said time-out indicator includes a timer providing a time-out signal corresponding to an excess cranking time of said starter.

8. The internal combustion engine of claim 7, further including a starter switch having a start position, said timer corresponding to a time that said switch is in said start position.

9. A starter system for an internal combustion engine, comprising:
a starter;
at least one starter parameter indicator, each said indicator providing an output signal representing one of a start and no-start condition for said starter; and
an engine control module coupled with said starter and said at least one indicator, said engine control module controllably actuating said starter, dependent upon said output signal from each said indicator, and
wherein each said indicator includes one of a run condition of said internal combustion engine and a cranking time of said starter.

10. The starter system of claim 9, further including a starter switch having a start position, said engine control module coupled with said switch and controllably actuating said starter, dependent upon said output signal from each said indicator and said start position of said switch.

11. The starter system of claim 10, wherein said engine control module actuates said starter, dependent upon a logical boolean operation of each of said output signal from each said indicator and said start position of said switch.

12. (canceled)

13. (canceled)

14. The starter system of claim 9, wherein said run indicator includes an RPM sensor providing an output signal representing an RPM of said internal combustion engine.

15. The starter system of claim 9, wherein said time-out indicator includes a timer providing a time-out signal corresponding to an excess cranking time of said starter.

16. The starter system of claim 15, further including a starter switch having a start position, said timer corresponding to a time that said switch is in said start position.

17. A method of operating an internal combustion engine, comprising the steps of:
requesting an energization of a starter; verifying at least one starter parameter indicator representing one of a start condition and a no-start condition for said starter; and
controllably actuating said starter, dependent upon said requested energization of said starter and each said indicator corresponding to a start condition, and
wherein said at least one indicator includes two indicators, one said indicator comprising a run indicator indicating said run condition of said internal combustion engine, and an other said indicator comprising a time-out indicator indicating said cranking time of said starter.

18. The method of operating an internal combustion engine of claim 17, wherein said requesting step comprises engaging a starter switch to a staff position.

19. The method of operating an internal combustion engine of claim 18, wherein said controllably actuating step is carried out when said starter switch is in said start position and each said indicator corresponds to a start condition.

20. (canceled)

21. (canceled)

22. The method of operating an internal combustion engine of claim 17, wherein said run indicator includes an RPM sensor providing an output signal representing an RPM of said internal combustion engine.

23. The method of operating an internal combustion engine of claim 17, wherein said time-out indicator includes a timer providing a time-out signal corresponding to an excess cranking time of said starter.
